(19) United States
(12) Patent Application Publication
(10) Pub. No.: US 2012/0075626 A1
(43) Pub. Date: Mar. 29, 2012

(54) UNIVERSAL TESTING PLATFORM FOR MEDICAL DIAGNOSTICS AND AN APPARATUS FOR READING TESTING PLATFORMS

(76) Inventors: Ziv Geva, Nes-Ziona (IL); Ofer Leizerovich, Nes-Ziona (IL)

(21) Appl. No.: 13/246,053

(22) Filed: Sep. 27, 2011

Related U.S. Application Data
(63) Continuation of application No. 13/057,866, now abandoned.

(51) Int. Cl. G01N 21/01

(52) U.S. Cl. 356/244

(57) ABSTRACT

A method and an apparatus for optically reading test devices having an identification data zone associated with the test device and test zone arranged to receive a sample. The apparatus comprises an optical sensing module, an image processing module coupled to the optical sensing module, a control module coupled to the optical sensing module and to the image-processing module. The optical sensing module is arranged to sense both the test zone and the identification data zone and deliver the sensed data to the image processing module responsive to the control module. Further, the image-processing unit is arranged to perform image processing on the sensed data from the test zone and from the identification data zone and further determine the sample according to the sensed data from the test zone in view of the sensed data from the identification data zone responsive to the control unit.

### FIELD OF THE INVENTION

The invention relates to analysis of samples (for example, blood, urine, saliva, or swab) to determine the presence or absence of an analyte such as a pathogen.

### BACKGROUND

Rapid test devices directed at examining chemical and biological substances for analysis and diagnostic purposes are widely used and are often replacing some of the traditional laboratory tests. Theses test devices cover various types of tests and are used for example, in human diagnostics, veterinary uses, and in food and environmental tests.

Many of these test devices utilize a chemically responsive substance contained in a predefined zone on the test device. The chemically responsive substance is selected such that it interacts with the test specimen and presents optical formation representing the detected substance in the specimen in accordance with predefined parameters. The optical representation may be either qualitative (e.g., binary or discrete value) or quantitative (e.g., specified by the intensity, shape or color of the reaction, or by a combination). A test device might contain a control zone to verify that the test is valid, and also might contain several test zones, either for the same test or for multiple tests on the same test device.

Several testing platforms allow for the analysis of only a single type of sample, and require manual manipulation to activate the test. For example, the Strep A Twist Cassette by Innovacon/ABON has a sample preparation chamber that separates liquid from the test strip until the end user opens the valve by rotating the chamber. The twist cassette platform is specific for a swab sample. The exit valve in the twist cassette is on a circular twisting plastic piece. The configuration of the valve requires manual intervention.

Digital readers for the examination of test devices focusing on optical image processing are becoming available, and are designed such that they imitate the diagnostic method performed manually, either with bare eyes or by using a microscope or magnifying glasses. These readers further employ image-processing techniques in order to improve the human acts of examination and diagnosis. The improvements are achieved by applying additional sensitivity and abilities such as providing numeric results supporting wavelength beyond the eye, adding storage and connectivity, etc. The rapid test devices are provided with a designated area on which the specimen is held and where the chemically responsive substance is embedded thereon.

Some rapid test devices operate when associated with a reader to which the test device is connected or coupled. The reader is arranged to communicate with an examination device and to receive additional data relating to the specimen such as test identification, patient information and specific batch information. The data is then further processed for diagnostic purposes.

Several attempts are known in the art to design portable devices for the examination of bodily substances and other chemical specimens.

In many cases data that is unique to a specific examination device is beneficial to obtaining an optimal and precise diagnostic process. This data usually pertains to technical details relating to the production process of the specific examination device such as batch number, date of production, model and type of device and the like. This device related data is used to calibrate the reader and for other processes that influence the quality of the diagnostic procedure.

U.S. Pat. No. 7,267,799, the entire content of which is incorporated herein by reference, is addressed to provide a universal optical imaging test system comprising a reader and a method to provide the reader with calibration data. However, the data relevant to the test and the data relevant to calibration are transferred in different manners.

It would be advantageous to have a reader that enables the use of the same method and same optical sensing means for reading the specimen related data and peripheral data pertaining to the test device, the patient information such as ID, name and his or her biometric stamp and the like.

### BRIEF SUMMARY

In embodiments, the invention relates to analysis of samples (for example, blood, urine, saliva, or swab) to determine the presence or absence of an analyte such as a pathogen. Embodiments include a diagnostic testing platform, which may also be referred to as a test device. The platform may permit the analysis of a plurality of different samples with no or only minor modifications made to the platform. This platform may also reduce the number of steps performed by a user, and offer increased sensitivity and precision. The platform may be integrated with a low-cost apparatus and provide an accurate digital analysis of the reaction.

In embodiments, the invention also relates to an apparatus, for example a reader, such as portable readers for the examination of biological and chemical specimens on a test device, and for example to an apparatus that enables the optical reading of data pertaining to the specimens as well as data pertaining to the test device, the patient, donor or person in charge to conduct the test.

In embodiments, a test device includes a cassette. The cassette typically includes a bottom portion, a top portion, and a chamber. The chamber may have an applicator receiving portion for receiving a sample applicator. A test strip may be located between the bottom portion and the top portion of the cassette. The device may include a passage connecting the chamber and the test strip.

The device may include a valve movable from a first position to a second position. In the first position, the valve obstructs the passage. In the second position, the valve allows sample to flow through the passage from the chamber to the test strip. In embodiments, the valve is moved by a motor, for example a stepper motor. In embodiments, the valve is a lateral or linear sliding valve or a rotating valve.

The top portion of the cassette may have a test strip window for viewing a portion of the test strip. The top portion of the cassette may also include an identification data zone, e.g. at least one label, for example, a barcode. The at least one label may be located adjacent to the test strip window. The at least one label may be, for example, a 1D barcode or a 2D barcode.

In embodiments, the chamber may be cylindrical or circular. In embodiments, the chamber may have a wall that is smooth. In embodiments, the chamber wall may contain grooves or ridges.

In embodiments, the chamber is a reaction chamber in which, for example, the sample may be reacted with one or more reagents. The chamber typically contains a reagent, for example, a labeled antibody pellet. The chamber may also include a sample mixing apparatus. For example, the sample mixing apparatus includes a magnet and a magnetic stirring motor designed to mix the labeled antibody pellet and the sample.

In embodiments, the test strip may include one or more of a sample receiving pad for receiving a sample; a nitrocellulose membrane which typically includes a test zone; and an absorbent pad for absorbing excess sample. The test strip may also include a bridge pad.

In embodiments, the chamber may include an applicator receiving portion. The applicator receiving portion may be, for example, a swab cone for receiving a swab applicator, a net for receiving a saliva collector, a liquid filter, a buffer pad, or at least one blood separation pad.

In embodiments, a sample is typically applied to the applicator receiving portion of the chamber of the test device. The sample may be processed in the applicator receiving portion to prepare a processed sample. In embodiments, the sample is processed, for example, by extracting saliva from a swab or saliva collector, by filtering or buffering (e.g. filtering or buffering a urine sample), or by separating the sample (e.g. by separating red blood cells from a remainder of the sample).

The sample, e.g. the processed sample, and a reagent are typically mixed in the chamber to prepare a mixed sample. In embodiments, the sample, e.g. the processed sample, and the reagent are mixed using a sample mixing apparatus, for example, a magnet located in the chamber and a magnetic stirring motor.

The sample from the chamber may be applied to a test strip of the test device by moving a valve from a first position to a second position. In embodiments, the valve may be moved from the first position to the second position by an apparatus. In embodiments, the valve may be a lateral or linear sliding valve. In embodiments, the valve may be a rotating valve.

In embodiments, the test device may contain a test zone and an identification data zone. The test zone is typically located on the test strip. The identification data zone may be located, for example, on the cassette of the test device, or on the test strip.

The test device and test strip may be analyzed using an apparatus, for example, a reader for reading the test device. The test strip may be analyzed, for example, to determine a positive result or negative result, or to detect the concentration level of an analyte in the sample. The test strip or test device may also be analyzed to read an identification data zone, e.g. a label located on the test strip or the cassette of the test device. The label may be, for example, a barcode.

In embodiments, an apparatus is provided for reading (e.g. optically) test devices having an identification data zone associated with the test device and test zone arranged to receive a sample. The apparatus may comprise an optical sensing module, an image processing module, and a control module. The image processing module is typically coupled to the optical sensing module. The control module is typically coupled to the optical sensing module and to the image processing module. The optical sensing module may be arranged to sense both the test zone and the identification data zone. The optical sensing module may also deliver the sensed data to the image processing module responsive to the control module. Further, the image-processing unit may be arranged to perform image processing on the sensed data from the test zone and from the identification data zone and further determine the sample according to the sensed data from the test zone in view of the sensed data from the identification data zone responsive to the control unit.

In embodiments, a biological substance specimen may be analyzed (e.g. optically) by an examination device, and data relating to the specimen and further data relating to the production process of the examination device may be transferred to the device. A biological substance specimen may be optically sensed, and the sensed data is typically processed. The processed data and the data relating to the production process of the examination device may be transferred to the examination device.

### BRIEF DESCRIPTION OF THE DRAWINGS

FIG. 1 is a top view of a bottom portion cassette of a test cassette.

FIG. 2 is a top view of the cassette.

FIG. 3 is a top view of the top portion of the cassette.

FIG. 4 is a bottom view of a bottom portion of the cassette.

FIG. 5 is a top view of a cassette with barcodes.

FIG. 6 is a 3D view of a swab cone.

FIG. 7 is a top view of a saliva collector net and filters holder.

FIG. 8 is a top view of the cassette with a labeled antibody pellet and magnetic stirrer.

FIG. 9 shows the linear valve of the cassette coupled to the stepper motor of the apparatus.

FIG. 10a shows a first position of a valve during sample incubation.

FIG. 10b shows a second position of a valve during sample run.

FIG. 10c shows a third position of a valve with conjugates running downstream.

FIG. 11a is a side view of the device of FIG. 10a.

FIG. 11b is a side view of the device of FIG. 10b.

FIG. 11c is a side view of the device of FIG. 10c at the start of the conjugate reverse run step.

FIG. 11d is a side view of the device of FIG. 10c during the conjugate reverse run step.

FIG. 11e is a side view of the device of FIG. 10c showing an antigen capture read line and a control read line.

FIG. 12a shows a two-stage sliding linear valve in a first position during sample incubation.

FIG. 12b shows a two-stage sliding linear valve of FIG. 12a in a second position during sample run.

FIG. 12c shows a two-stage sliding linear valve of FIGS. 12a and 12b in a third position with chase buffer.

FIG. 13a shows a linear sliding valve in a first position during reverse flow conjugate application.

FIG. 13b shows a linear sliding valve in a second position during reverse flow conjugate application—sample run upstream.

FIG. 13c shows a linear sliding valve in a third position during reverse flow conjugate application—conjugate run downstream.

FIG. 14a shows a linear sliding valve in a first position during reverse flow of biotin conjugate and Au conjugate after sample application.

FIG. 14b shows a linear sliding valve in a first position during sample run.

FIG. 14c shows a linear sliding valve in a second position during simultaneous release of biotin conjugate and neutravidin conjugate chase buffers.

FIG. 15a shows a linear sliding valve in a first position during reverse flow conjugate application during sample incubation.

FIG. 15b shows a linear sliding valve in a second position during reverse flow conjugate application with sample run upstream.

FIG. 15c shows a linear sliding valve in a first position during reverse flow conjugate application with both conjugates run downstream.

FIG. 15d is a side view of FIG. 15c.

FIG. 16a is a side view of a blood sample assay cassette with sample/red blood cell separation on the test strip.

FIG. 16b is a side view of a blood sample assay cassette with sample/red blood cell separation in the chamber.

FIG. 16c is a side view of a blood sample assay cassette with buffer storage and sample/red blood cell separation in the chamber.

FIG. 16d is a side view of a blood sample assay cassette with buffer storage in the chamber.

FIG. 17 is a block diagram showing the apparatus according to some embodiments;

FIG. 18 is a flow chart showing stages of the method according to some embodiments;

FIG. 19 shows a flowchart depicting stages of a variation of the method according to some embodiments; and

FIG. 20 is an isometric view showing the apparatus according to some embodiments. The drawings together with the description make apparent to those skilled in the art how the invention may be embodied in practice.

### DETAILED DESCRIPTION

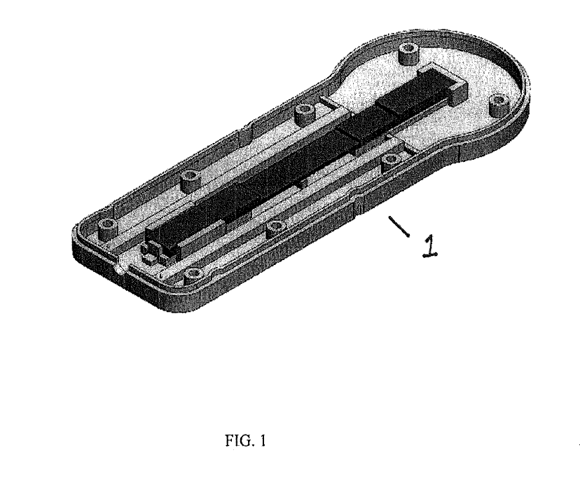

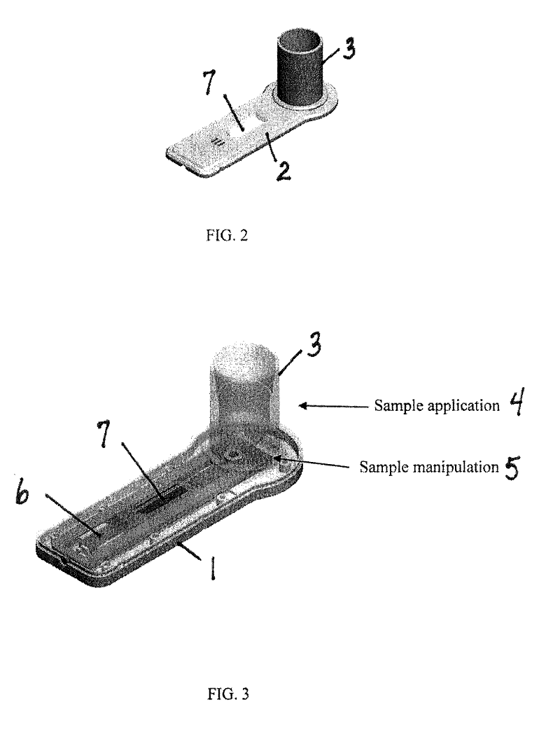

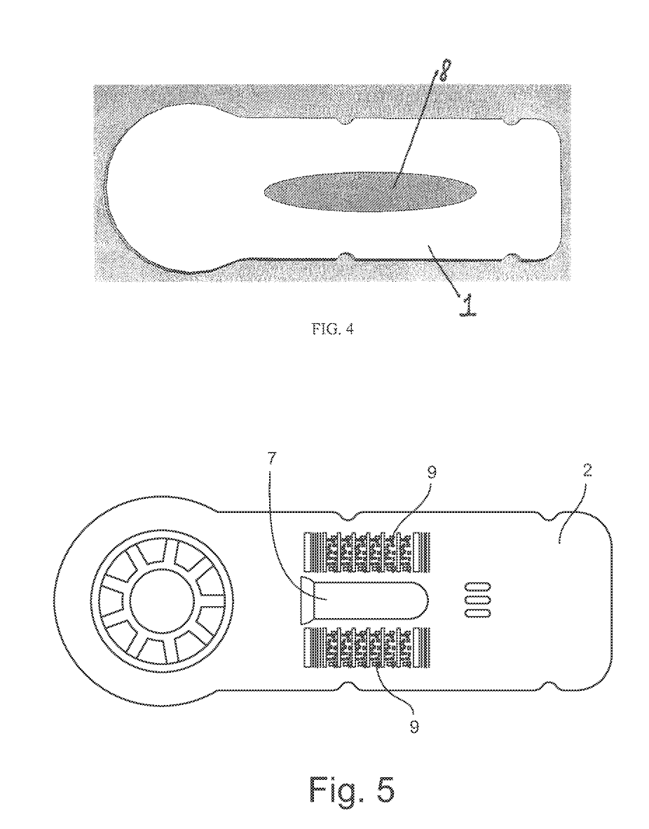

In embodiments, a diagnostic test comprises a cassette, an apparatus for reading the cassette, and an applicator for applying sample to the cassette. The diagnostic test may be used with our without an apparatus, e.g. an automated reader. Referring to FIGS. 1-3, a cassette is typically composed of a bottom portion 1, a top portion 2, and a chamber 3. In embodiments, the chamber 3 is cylindrical or barrel-shaped. The chamber 3 may include an applicator receiving portion 4 for receiving a sample applicator.

The bottom portion 1 of the cassette typically holds a test strip 6. The test strip 6 is typically located between the bottom portion 1 and the top portion 2 of the cassette, lying flat along the bottom portion 1. The top portion 2 may have a viewing window 7 for viewing a portion of the test strip 6. The test strip 6 typically includes a sample receiving pad, a nitrocellulose membrane, and an absorbent pad. In embodiments, the test strip 6 may also include a bridge pad. In embodiments, the test strip 6 typically contains antibodies dried onto the nitrocellulose membrane at specific locations, for example, in the test zone. The test strip 6 may be sized to fit within the bottom portion 1, for example, about 1 mm to about 10 mm in width and about 40 mm to about 80 mm in length. The cassette may be modified to accept test strips of various lengths and widths.

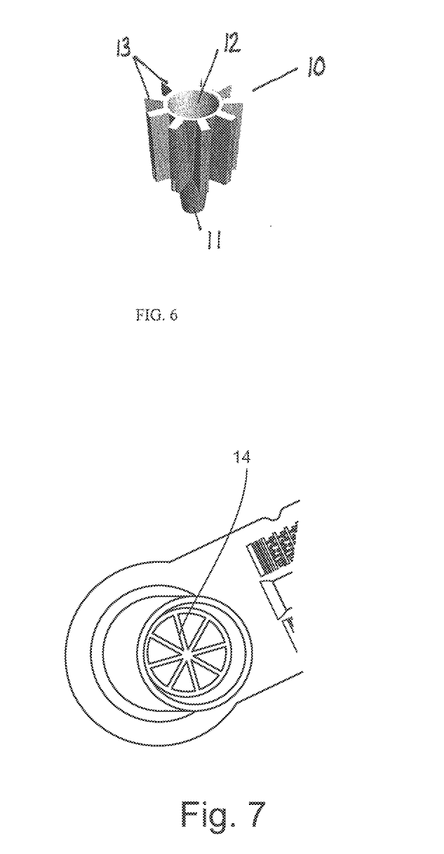

In embodiments, for example as shown in FIG. 4, the bottom portion of the cassette 1 may include a cutout 8 so that light can be illuminated from the bottom and detected from above. The cutout may be, for example, circular or oval shaped. In this embodiment, the test strip is typically made out of a clear backing material. This embodiment allows light transmission and/or light reflectance to be measured.

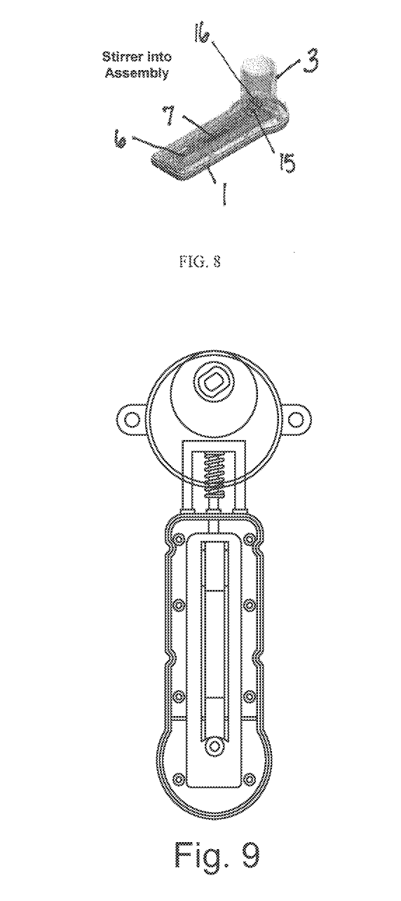

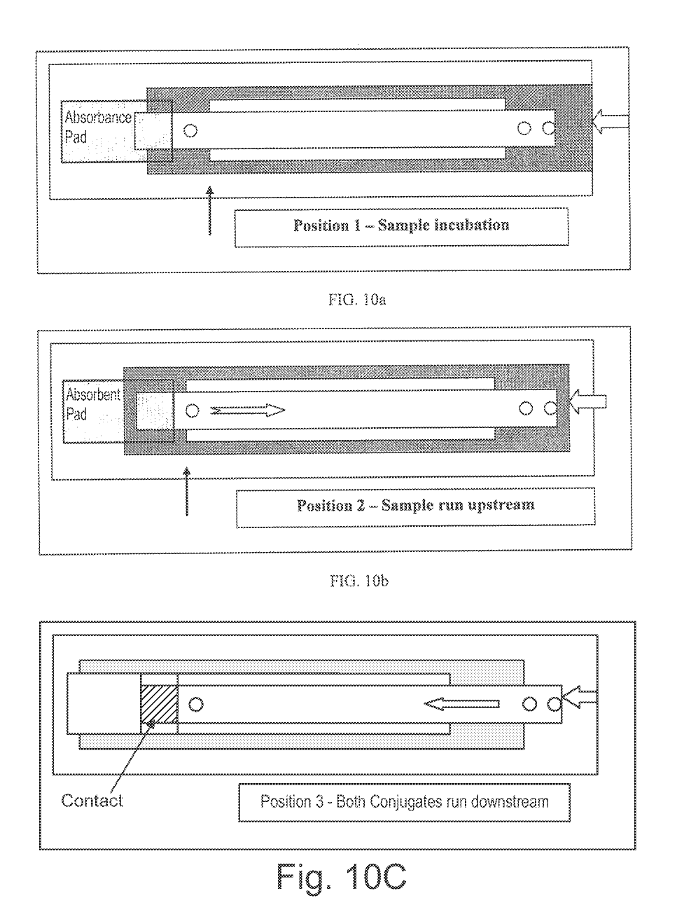

As shown in FIG. 5, the top portion 2 may also include an identification data zone, e.g. labels, for example, barcodes 9. The labels or barcodes may be located on either side of the test strip window 7. The labels or barcodes 9 are readable by the apparatus. The labels may be, for example, 1D or 2D barcodes. In embodiments, the label or barcode 9 is typically at the same general focal position as the test strip to minimize errors.

The chamber typically has an opening, e.g. a sample receiving portion, for accepting a variety of sample applicators, which are described below. Examples of sample applicators include a swab applicator or a saliva collector. Each of the applicator receiving portions described below may be designed to pre-process the sample prior to the sample entering the sample manipulation zone, for example, by extracting saliva from a swab or saliva collector, filtering and buffering a urine sample, or separating red blood cells from the remainder of the blood sample. Having the sample application zone separate from the bottom of the chamber allows for other activities to take place in the bottom of the chamber, thus creating two distinct zones, a sample application zone and a sample manipulation zone. The applicator receiving portion may also be designed to keep sample added to the chamber away from a sample manipulation zone.

In embodiments, the applicator receiving portion of the chamber is a swab cone 10 for receiving a sample applicator, e.g. a swab, such as a throat swab, or a sample collector, such as a foam saliva collector. A user typically inserts a swab or sample collector into the chamber. Buffer may be added to the chamber. The swab cone 10 typically inhibits the flow of liquid until the swab or sample collector is removed. This allows for better transport of material off of the swab or sample collector because the swab or sample collector is submerged in buffer. The swab or sample collector at least partially obstructs the bottom hole 11 of the cone 10 until it is removed so that the swab or sample collector can be mixed and swirled against the outer wall of the cone. The swab cone's inner surface 12 allows liquid to flow down its walls. The diameter and height of the cone allows various types of applicators to be inserted, for example foam tipped swabs or polyester swabs. A foam swab from Puritan has been shown to increase sensitivity. If it is not used, then the test can expect to lose about a ½ log in analytical sensitivity (it should also be noted that the examples below used this swab). The swab cone 10 may include outside fins 13, which serve to lock it into place against the wall of the top portion, which may be grooved or textured. The fins 13 also allow for air to travel up and down the chamber to stop air locks from occurring, and may assist in keeping a magnet and a reaction pellet located at the bottom of the chamber in place.

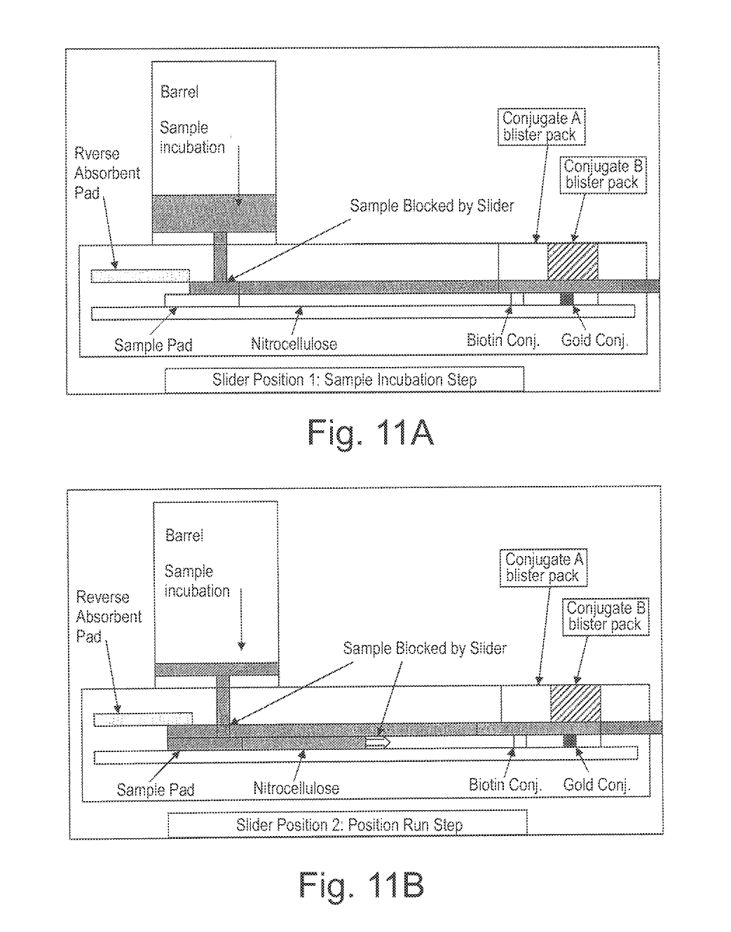

In embodiments, the applicator receiving portion includes a net 14, for example a net for extracting sample from a collector, as shown in FIG. 7. The net 14 allows an external collector, for example a saliva collector, to be squeezed or compressed against the net, allowing sample to be expelled. The collector may be made of foam. The net may be made of plastic. A filter pad can also be inserted on top of or below the net. The net 14 requires only a small amount of sample to be collected on the sample collector, because all of the fluid from the sample collector may be expelled directly into the sample manipulation zone. This can be a major advantage for tests conducted on people with dry mouth, where the amount of sample collected may be small.

In embodiments, the applicator receiving portion includes filter or buffer pad. For example, a filter or buffer pad may be placed into the chamber and may be locked into place with respect to the wall. The filter or buffer pad may be formed of Porex material, e.g. number 1342, and may have a disc shape (e.g. a 9/16″ diameter disc, 1/16″ thick). The disc may be dipped into a detergent buffer and dried to remove moisture. This applicator receiving portion allows sample, for example urine or saliva, to be added directly to the platform without the need to use a filtering swab, or to dilute with buffer.

In embodiments, the applicator receiving portion includes a separation and collection receiving portion, e.g. a blood separation and collection receiving portion. Separation of a blood sample may occur in the chamber of the device, or on the test strip. For separating the blood sample in the chamber, a sample application pad made of a material that separates red blood cells from the remainder of the sample may be located at the sample application point inside the chamber. Alternatively, there may be a series of separator pads that have differing properties that will transfer the sample without the red blood cells from the sample collection device (for example, a capillary tube) to the labeled antibody pellet in the chamber. For separating the blood sample on the strip, the sample pad under the chamber may be made of a blood separation material or a series of blood separators of differing properties that transfer the sample from the chamber to the test strip while retarding or immobilizing the red blood cells. Examples of separation pad materials that may be used include, for example, VF1, VF2, MF1, and LF1 materials (GE Whatman) or Cytosep (Pall) material. In embodiments, the sample pads are a series of red blood cell separation pads that immobilize the red blood cells in a flowing sample and keep them from staining the nitrocellulose. In embodiments, the sample pad(s) may be a single pad that separates the blood sample, or two or more pads in a series to accomplish red blood cell immobilization. Antibody against red blood cells can be added to one or more of the pads to assist in the immobilization of the red blood cells.

The chamber typically contains a valve, for example, a linear sliding valve or a rotating valve. The valve may operate via a linear sliding piece, which may be made of plastic. The valve hole may be tapered, and the bottom portion of the cassette is typically adapted to push the sample pad of the test strip toward an exit hole of the valve. The step of opening the valve may be automated. Automation of the valve opening step not only reduces the number of steps to be performed by a user, but also reduces technician error due to incorrect timing or incorrect opening of the valve. A motor, e.g. a stepper motor, of the apparatus pushes a sliding piece into place, which allows a valve hole located on the valve to line up with a hole on the top portion of the cassette. The top portion of the cassette may hold the valve in place. The space surrounding the valve is typically sealed, e.g. with an o-ring. The valve allows for two separate zones: one for sample application, and one for sample manipulation.

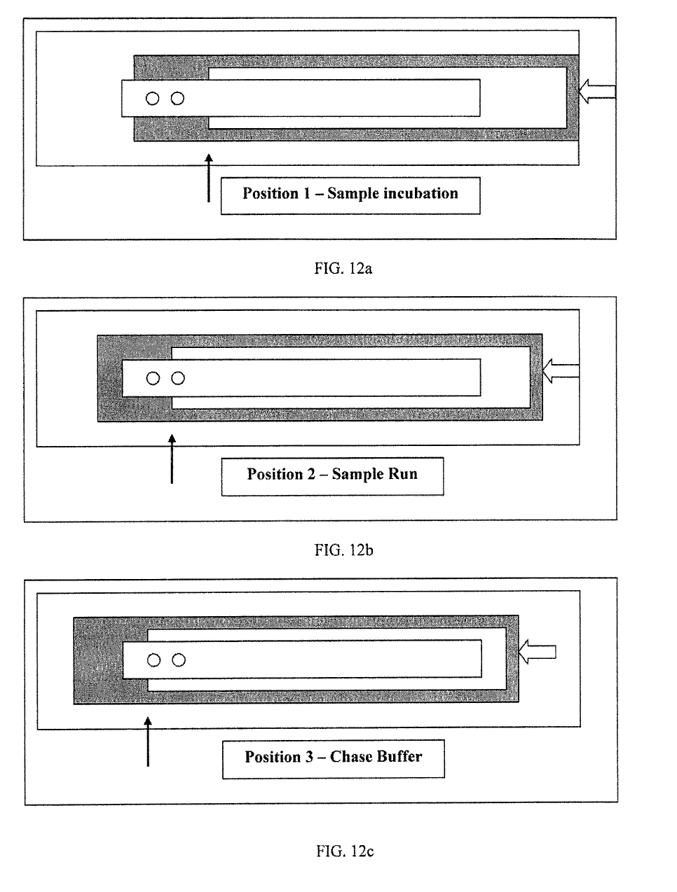

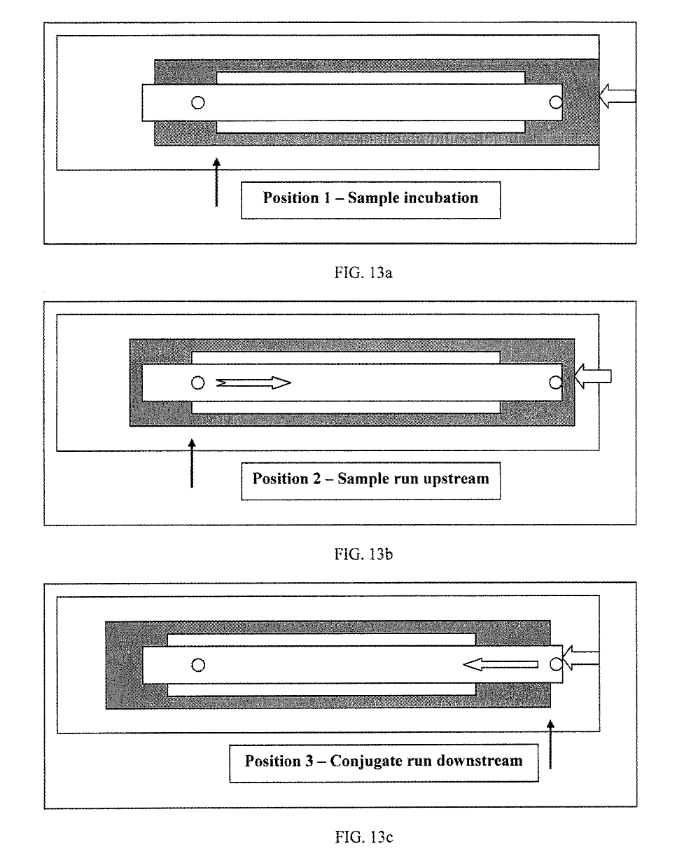

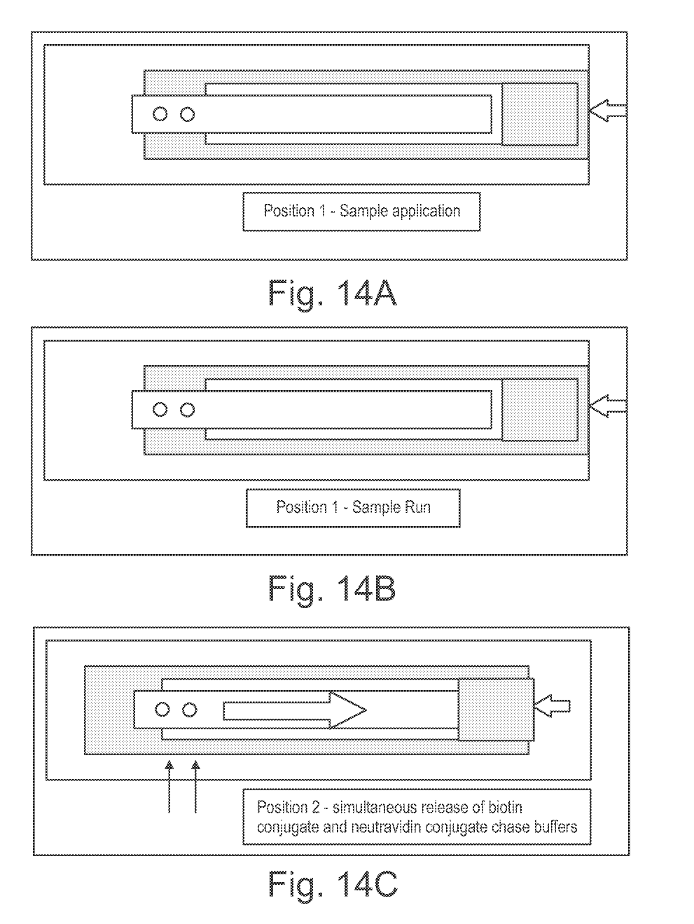

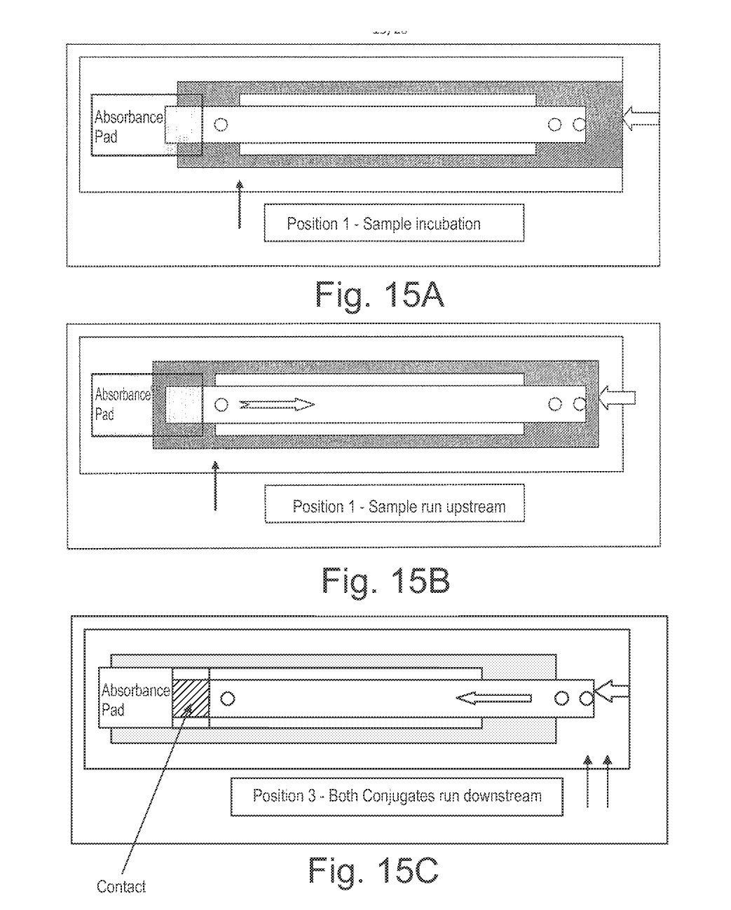

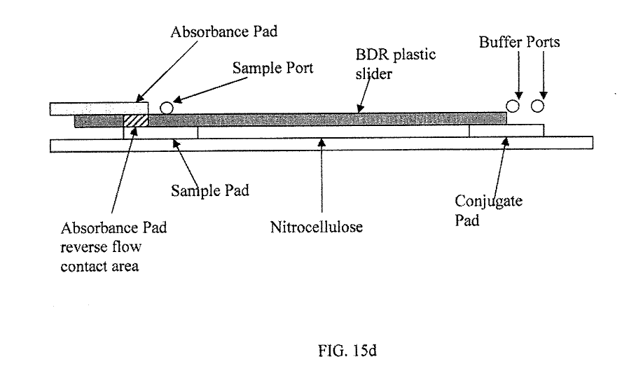

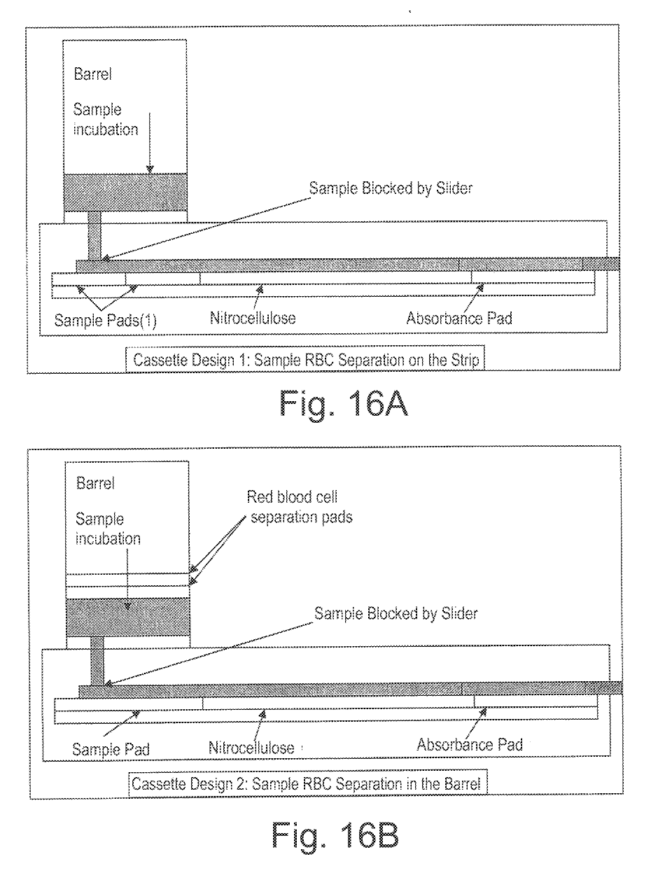

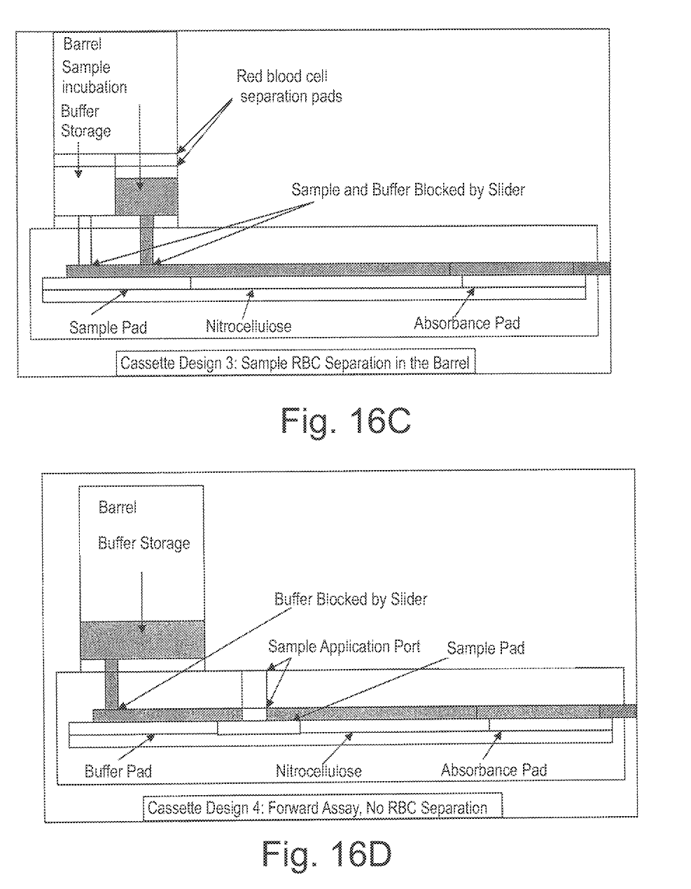

FIGS. 10-16 show alternative embodiments of the test cassette. In embodiments, the valve may have a first position and a second position. In the first position, the valve typically obstructs a passage between the chamber and the test strip. In the second position, the valve may allow sample to flow through the passage from the chamber to the test strip. The valve may also be moved from a second position to a first position if a sufficient amount of fluid has contacted the test strip, or if a specific amount of time has passed. This allows the amount of liquid to be controlled based on time. For example, the motor of the apparatus may push the valve to the open position and then, based on empirical time testing, pushes the valve to the second closed position when the required amount of time had passed.

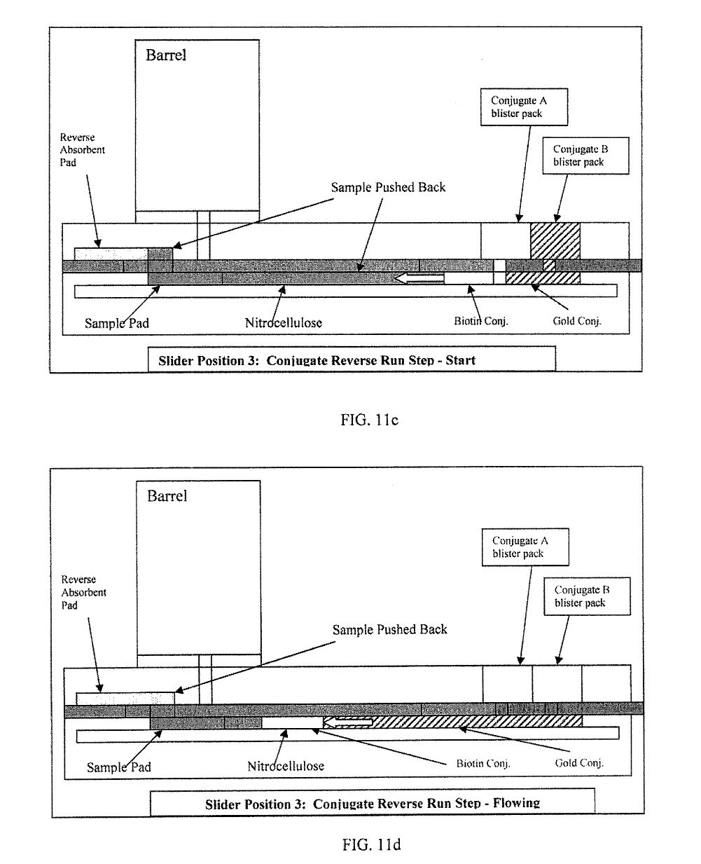

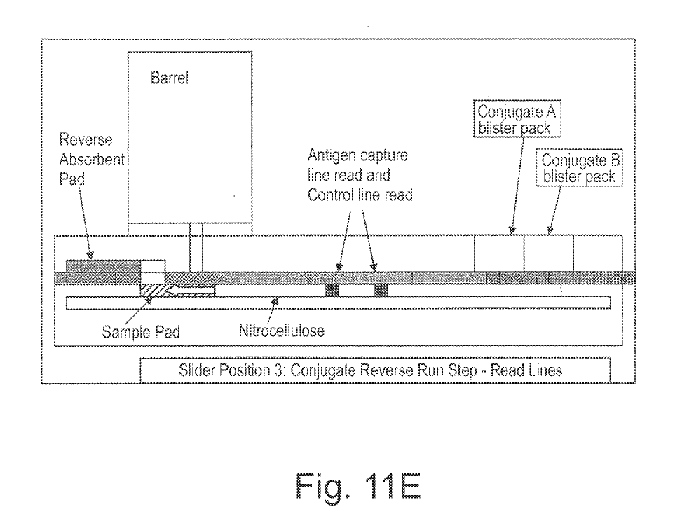

Referring to FIG. 8, the chamber typically contains a reagent, e.g. a reagent pellet 15, e.g. a labeled antibody pellet, located within the chamber 3. The reagent pellet 15 includes components to treat the sample in the sample manipulation zone and create a detectable reaction product. The components could include antibody conjugated to a gold colloid, an extraction enzyme, protecting proteins or buffering reagents. In embodiments, the labeled antibody pellet is a gold bead containing antibodies conjugated to gold and a PlyC enzyme. Using a reagent pellet 15 instead of absorbing labeled antibodies onto the test strip allows for all of the sample to mix with all of the antibody conjugate. This decreases imprecision due to reconstitution and kinetics. The reagent pellet 15 increases sensitivity and precision of the device, because it allows the device to detect low levels of analyte and decreases the likelihood of variation. The device may be used without any manual manipulation by a user or operator. The reagent pellet 15 may be inserted into the cassette barrel 3 at the time of manufacture. In embodiments, an exothermic chemical reaction could be included with the reagent pellet 15 to produce a warm liquid prior to chromatography. In these embodiments, the opening and closing of the valve may help regulate the temperature.

In embodiments, an apparatus-based Streptococcus A (Strep A) test may use a rapid immunochromatographic cassette and an apparatus to detect group A Streptococcus from a patient sample, e.g. a throat swab. Traditional Strep A tests typically utilize micronitrous acid extraction to liberate the group A antigen. This method is both time consuming (1-2 minutes) and is not complete (Kholy et al., “Simplified Extraction Procedure for Serological Grouping of Beta-Hemolytic Streptococci,” Applied Microbiology, November 1974, Vol. 28, No. 5, p. 836-839.). In contrast, the present Strep A test typically utilizes a phage-associated lysine, PlyC, to extract the group A antigen. The PlyC has been shown to provide complete hydrolysis within a matter of seconds. The recombinant lysin is currently provided by New Horizons Diagnostics. The protein is expressed in E. coli cells and is purified on a hydroxyl apatite column. (WO 2004/104213—The Rockefeller University.)

The present test may utilize a foam-tipped swab instead of the woven polyester swabs used in traditional tests. This may increase sensitivity, lessen user discomfort, and minimize the need for transport media. The present test also utilizes a low-cost apparatus that may perform the steps of mixing of sample, automatically incubating of the sample, and analyzing the reaction. The apparatus may reduce the number of steps to be performed, minimize ambiguity with low-level signals, provide quicker results, and minimize transcription errors by transmitting results directly to patient records.

The apparatus-based Strep A test may also employ antibodies that are more sensitive and more specific than most tests currently on the market. A sheep antibody laid down on the nitrocellulose in a wide line may increase the capture line efficiency at limit of detection and may be pre-scrubbed against cross-reacting bacteria. The sheep anti-Strep A antibody may be BAA, an antibody produced by ADAPT using an ABBOTT immunogen, or an antibody produced by Binax, Inc. The sheep anti-Strep A antibody may be scrubbed against three different strains of Neisseria to help eliminate cross reactivity prior to purification. A rabbit anti-Strep A antibody (18A) provided by New Horizon Diagnostics may also be used. The label used is typically a gold colloid, and the sample is typically mixed with the gold prior to chromatography. The antibody used on the gold particle (NHD 18A) has also been shown to be the most sensitive and specific anti-Strep A antibody.

A sample mixing apparatus may also be located within the chamber 3, as shown in FIG. 8. The function of the sample mixing apparatus may be controlled by the apparatus. Mixing is typically accomplished by a magnet 16 and a magnetic stirring motor. The magnet 16 may be inserted into the cassette barrel at the time of manufacture. Any shape of magnet can be used. In embodiments, the magnet 16 may be a trapezoid or square shape. The magnet allows for the mixing of samples with buffer, extraction reagents, and or labeled antibody and eliminates uniformity problems with viscous samples. The speed, duration and action of the stir is fully controllable by software on the apparatus. This is useful for mixing viscous samples with the reagent pellet and for increasing kinetics of antigen-antibody interactions. In addition, complete sample preparation is may be completed prior to chromatography.

Once the sample has been mixed and incubated with the reagent pellet for the proper amount of time, the valve is typically pushed open by the motor of the apparatus. When the valve is opened, the liquid solution is able to travel through the valve hole and onto the sample receiving pad of the test strip. Chromatography begins and the reaction is measured. In embodiments, a chase buffer (e.g. a push buffer) may be added to the chamber after the sample is loaded or after the incubation time is complete. In embodiments, the chase buffer or push buffer may be included in the chamber and may be applied to the test strip with the sample or after the sample using an offset valve port on the sliding piece and a second slide of the sliding piece when programmed. In embodiments, conjugate buffers may be contained in blister packs.

The apparatus typically employs the use of a signal detection device, such as a camera, e.g. a CMOS camera, with several algorithms and decision trees to detect the signal. The apparatus analyzes the test strip periodically, e.g. every 10-15 seconds, until certain criteria are met, for example, a positive or negative result is determined, or a certain analyte concentration level is detected. Software in the apparatus may allow the location of the detection lines to be altered without changing the design of the system. The apparatus may connect to the software for automatic download of data, e.g. via Bluetooth.

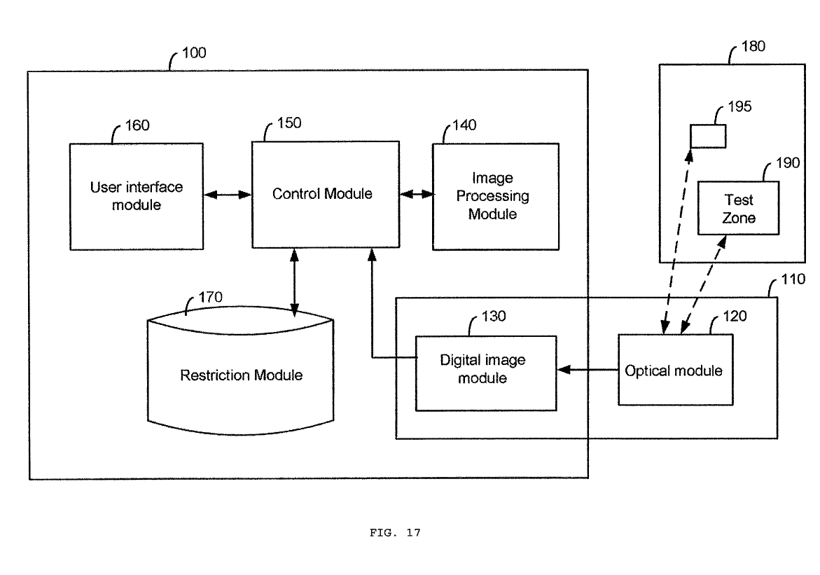

FIG. 17 shows a high level schematic block diagram of an apparatus (e.g. a reader) 100 for reading test devices 180, e.g. optically. The test device 180 typically has an identification data zone 195 (e.g. a label, for example a barcode) and a test zone 190. The apparatus 100 may include a sensing module 110, e.g. an optical sensing module, comprising an optical module 120, an image module 130 (such as a digital image module), an image processing module 140, and a control module 150. The image processing module 140 may be coupled to the sensing module 110. The control module 150 may be coupled to optical sensing module 110 and to image processing module 140.

Sensing module 110 may be arranged to sense both test zone 190 and identification data zone 195 (either simultaneously or sequentially). Sensing module 150 may deliver the sensed data to image processing module 140 responsive to control module 150. Further, image processing module 140 may be arranged to perform image processing of the sensed data from test zone 190 and from identification data zone 195 and further determine the sample according to the sensed data from test zone 190 in view of the sensed data from identification data zone 195 responsive to control unit 150.

In embodiments, apparatus 100 may be arranged to be operatively associated with a plurality of test devices, each designed to perform a different test directed at a different sample or a different analyte. The sample may be varied such as biological material, bodily substance, chemical specimen and the like. The type of test and/or other parameters are determined by sensing the test zone and the data zone, e.g. optically.

In embodiments, the identification data may be any kind or format of data that pertains to the test device itself and that may be used in the image processing process of the test zone. Non-limiting examples of identification data may comprise type of test, mode of test, calibration data, date of production, identification number, batch number, biometric information (for example a fingerprint image placed in the data zone), and the like.

In embodiments, test zone 190 may be arranged to receive a sample and provides a visual representation of properties pertaining to the sample according to a predefined key.

In embodiments, sensing module 110 may be arranged to optically sense test zone 190 and identification data zone 195 simultaneously.

In embodiments, sensing module 110 may be arranged to optically sense test zone 190 and identification data zone 195 sequentially.

In embodiments, the apparatus 100 may read the test device without scanning or moving the test device with respect to the apparatus.

In embodiments, sensing module 110 may include an optical unit 120 and a digital imaging module 130. The digital imaging module 130, image processing module 140, and control module 150 may be implemented on the same integrated circuit.

In embodiments, apparatus 100 may include a printed circuit board. The sensing module 110, the image processing module 140, and the control module 150 may be implemented on the same printed circuit board.

In embodiments, apparatus 100 may include a power source, e.g. a rechargeable power source. The power source may comprise an electromagnetic power source operatively associated with a complementary power source activator located on the test device 180. Charging of the power source may be achieved in cooperation of the apparatus and the test device by converting mechanical force into electrical power.

In embodiments, apparatus 100 may include a restriction module 170 coupled to the control module. Restriction module 170 may be arranged to store restriction data pertaining to restricting the use of the test devices. The control data may further be arranged to restrict the use of the apparatus responsive to the restriction data. Restriction data may be any one of the following non-limiting examples: an upper bound of a number of test devices, identification data associated with predefined test devices, and the like.

In embodiments, apparatus 100 may include a user interface module 160. The user interface module may be coupled to the control unit. The user interface may be arranged to enable a user to select a mode and type of operation from a set of predefined modes and types of operation.

According to some embodiments, apparatus 100 may include a disposable portion and a reusable portion. The disposable portion may be arranged to disengage from the reusable portion. Alternatively the entire apparatus can be a disposable unit.

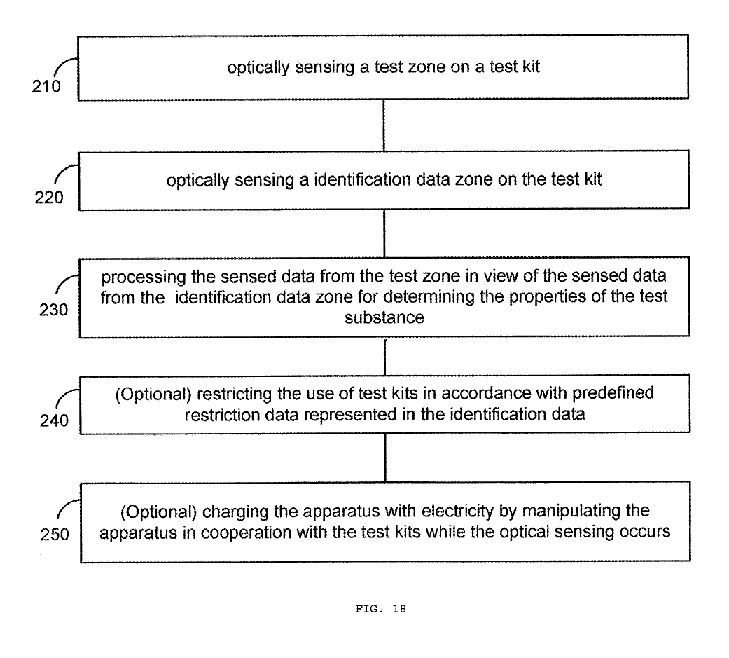

FIG. 18 shows a high level flowchart depicting a method of optically sensing a test device. In embodiments, the method may include steps of sensing the test zone 210 (e.g. optically); sensing the identification data zone 220 (e.g. optically); and processing the sensed data from the test zone in view of the sensed data from the identification data zone for determining properties of a sample 230. The steps of sensing the test zone and sensing the identification data zone may occur simultaneously or sequentially. In embodiments, the method may also include the step of restricting the use of test devices in accordance with predefined restriction data represented in the identification data 240.

According to some embodiments, the method includes charging the apparatus, e.g. with electricity, for example by manipulating the apparatus in cooperation with the test devices while the optical sensing occurs 250.

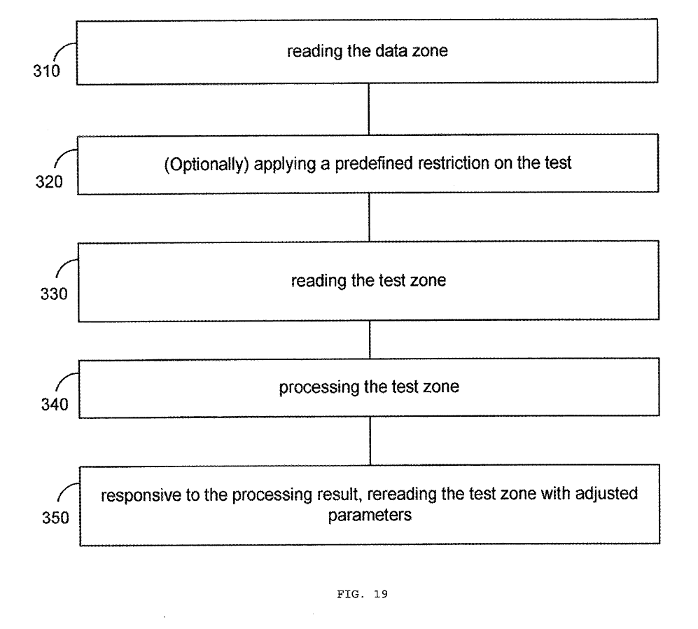

FIG. 19 shows a high level flowchart depicting stages of a method according to some embodiments. The method may include steps of reading the data zone 310; optionally applying a predefined restriction on the test 320; reading the test zone 330; processing the test zone 340; and responsive to (depending on) the processing result, rereading the test zone with adjusted parameters 350.

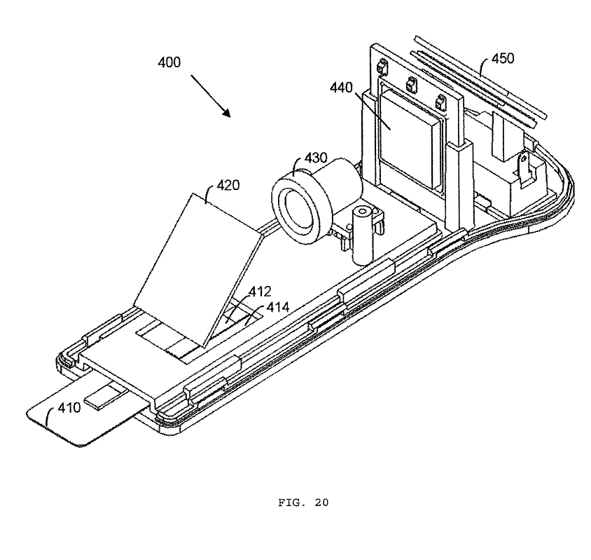

FIG. 20 is an isometric view showing the apparatus with the housing removed. The apparatus 400 according to this embodiment may be arranged to receive a test device 410 having a test zone 412 and an identification zone 414. In operation, test device 410 is typically inserted into an opening on the device, e.g. a dedicated slot. A mirror 420 may reflect the image of test zone 412 and identification zone 414 via a lens 430 to digital processing module 440. After analysis is performed in the processing unit, the information may be displayed on a display 450 or transferred via a data transference module. It is understood that other implementations are possible and the embodiment described above is merely an example.

In embodiments, the method may include analyzing biometric information and storing the analyzed biometric information associated with the test device. The biometric information may be presented on the test device from the sample taken from the patient/donor to perform the same test, or from an additional sample for the biometric identification itself. The biometric information may be an outcome from chemical or biological reaction that can be read by the optical system. Such information may include, for example, DNA prints, blood types, etc. The biometric information may be a photograph or a fingerprint, which may be attached to the device as a label. A fingerprint may be directly be printed on the test device by using ink, powder or any other mean for direct print on the test device.

In embodiments, the sample may be used to biometrically identify the test subject providing the sample. Further, the biometric identification may be used in conjunction with the test results in order to refer specific test results to a specific test subject (e.g., in drug tests). The biometric data may be taken from the tested biological sample or other biological material taken from the same human or animal. Such biometric material can be an intermediate form, such as photographs, images, prints and such information which relates to the test subject.

In embodiments, the apparatus may be arranged to conceal or encrypt the test results, making it difficult or impossible for a user to see or analyze the test results. The test result may be sent via a communication channel (e.g. USB, RF and the like) to a server or doctor to be analyzed in a remote site.

Portions of the apparatus may be implemented in one or more computer programs that are executable on a programmable system. The programmable system typically includes at least one programmable processor, a data storage system, at least one input device, and at least one output device. The at least one programmable processor may be coupled to receive data and instructions from, and to transmit data and instructions to, the data storage system. The computer program includes a set of instructions that can be used, directly or indirectly, in a computer to perform a certain activity or bring about a certain result. The computer program may be written in any form of programming language, including compiled or interpreted languages, and it may be deployed in any form, including as a stand-alone program or as a module, component, subroutine, or other unit suitable for use in a computing environment.

The program of instructions may be executed by processors, for example, both general and special purpose microprocessors. The program may be executed by a sole processor, or one of multiple processors. Typically, a processor will receive instructions and data from a memory, e.g. a read-only memory, a flash memory, a random access memory, or a combination thereof. Elements of a computer typically include a processor for executing instructions and one or more memories for storing instructions and data. Generally, a computer may also include, or be operatively coupled to communicate with, one or more mass storage devices for storing data files. Examples of mass storage devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the reader may be implemented on a computer having a display device, such as a LCD (liquid crystal display) monitor for displaying information to the user, and a keyboard and a pointing device (such as a mouse or a trackball) by which the user can provide input to the computer.

The apparatus may be implemented in a computer system that includes a backend component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a cellular telephony network, a LAN, a WAN, wireless LAN or Bluetooth, and the computers and networks forming the Internet.

The computer system may include clients and servers. A client and server are generally remote from each other and typically interact through a network, such as the described one. The relationship of client and server arises by virtue of computer programs running on the respective computers and having a client-server relationship to each other.

### EXAMPLES

### Example 1

### Apparatus-Based Group A Streptococcus Test

This example demonstrates acceptable analytical sensitivity and specificity of a target analyte (Strep A) in an exemplary matrix.

### Materials:

Apparatus-Based Strep A Cassettes:
RTG-A: Apparatus
RTK-Top portion of the Cassette
RTK-O ring
RTK-Linear valve
RTK-Strep A test strip
   G&L Laminated Backing (GL-51954)
   Nitrocellulose Sartorius CN95
      Cat#1UN95ER050025WS
      Lot#0308 19910 0703883
   ADAPT Sheep anti Strep A (BAA#021)
      1 mg/mL with 0.5% Trehalose 4 uL/cm
   Chicken IgY (1 mg/mL 1 uL/cm)
   Ahlstrom 1281 12.5 mm wide sample pad
   Porex 4588 12 mm wide bridge pad
   Ahlstrom 901 18 mm wide absorbent pad
RTK-Bottom portion of the Cassette
RTK-Magnet
RTK-Step A gold pellet (Processed by Biosite)
   Rabbit anti Strep A conjugate Lot 030948RD
   (Acid Clone 18 OD30, OD 9.375/test)
   Donkey anti Chicken conjugate (OD 30, OD 1.4/test)
      1 mg/mL PlyC (12.5 ug/test)
   Next Gen bead buffer
      9.5 mg/mL Tetra Borate
      50 mg/mL fraction five bsa
      300 mg/mL Sucrose
      12.5 mg/mL De-aggregated Rabbit IgG
      1 mg/mL Azide
      pH 7.2
RTK-Cone
Elution Buffer—R&D Formulation
   0.025M Sodium Citrate
   0.25M Tris Base
   0.025M EGTA
   0.25% SDS
   0.25% Nonidet P40
   0.05% Sodium Azide
   pH 7.2
Swabs: Foam tipped applicator (Puritan medical REF 25-1506 1PF solid)
Strep A dilution buffer: 1× PBS+0.05% Nonidet P40

### Apparatus: RTG-A Serial #6, Strep A Program

| | | | |
|---|---|---|---|
| | | TestType ID | 0 |
| Main Board ID | 6 | Test Name String | Strep-A |
| DeviceID | 6 | Thresholds 1-4 | 1200 |
| ScreenType | 0 | Control Threshold | 5000 |
| ScreenVoltage | 0 | Name of Left Line1 | Strep-A |
| BarcodeCheck | 0 | NI String | NO |
| | | | CONTROL |
| Lang | 0 | Minus/Minus String | NEGATIVE |
| DefaultTest | 0 | Plus/Minus String | POSITIVE |
| Message | RTR-Strep | Minus/Plus String | POSITIVE |
| | A | | |
| Home Steps | 0 | Plus/Plus String | POSITIVE |
| Open Steps | 1050 | Line1 Left/Right | 282, 603 |
| Return Steps | 0 | Control Left/Right | 640, 900 |
| Remove Well | 0 | LED 1-3 | 0, 32, 32 |
| VibratorCLK | 50 | Test Window X/Y | 212, 902 |
| VibratorPwr | 1 | Shutter Width | 2,500 |
| ReaderType | 1 | Gain | 16 |
| ShutterDelay | 0 | Stride | 0 |
| Downkey | 4 | Energy | 40,000 |
| SensorType | 2 | Test Image Width/ | 1,024, 210 |
| | | Height | |
| Checksum | 12 | Division Factor | 40,000 |
| | | Line 1 Type N = 0 W = 1 | 1 |
| | | UpperBound/ | 30, 30 |
| | | LowerBound | |
| | | Incubation time (s) | 2 (×10) |
| | | Wait time | 58 (×10) |
| | | Vibrator | 9 |

### Method:

In this example, the apparatus-based Strep A test included a cassette, an apparatus, a swab, and an elution solution. The cassette was comprised of a test strip, a magnet, a gold bead and a swab cone. The test strip included a nitrocellulose membrane, a sample pad, a bridge pad and an absorbent pad. An anti-Group A Streptococcus antibody provided by ADAPT BAA, and a control antibody, chicken IgY, were absorbed onto the membrane at specific locations. The test strip was 5 mm in width and 59.5 mm in length. The gold bead comprised rabbit anti-Strep A conjugated to gold, donkey anti-chicken conjugated to gold and the PlyC enzyme. The gold bead and magnet were inserted into the cassette barrel at the time of manufacture. The swab cone was inserted over the gold bead and magnet to lock them into place. The swab cone included an elution zone that blocked the flow of liquid until the swab is removed. The apparatus accepted the cassette, mixed the sample with the gold bead and automatically pushed the linear valve to initiate flow. The apparatus automatically analyzed the reaction every 10-15 seconds and reported the result based on threshold criteria. The apparatus connected via Bluetooth to PC software for automatic download of data.

For analytical testing, 10 uL of Strep A solution was added to the swab. The user inserted the swab into the patient's mouth and sampled the tonsils area. The user inserted the swab into the swab cone on the cassette. Elution solution was added to the cone by disposable transfer pipette ˜200 uL and the swab was mixed.

### Assay Protocol:

The cassette was removed from its packaging. The cassette was placed into the apparatus, and the apparatus detected the information to run the test. The swab was placed into the cone on the cassette. The elution solution was added to the cone. The swab was swirled several times (approximately 5 times) and removed. The swab was re-inserted into the cone and swirled around the rim of the cone to remove any excess liquid from the swab. It was then removed for the final time and discarded. The test button on the apparatus was pushed and the assay was started. The result was reported via the apparatus view screen (or via Bluetooth to a PC) when a signal was detected or the total end point criteria (control line intensity or time) was reached.

### Example 2

### Analytical Sensitivity Study

Group A Streptococcus (ATCC #19615) was evaluated during this study. Stock solutions diluted from the same frozen aliquot by two different individuals were used. Dilutions were prepared in Strep A dilution buffer. The test was stopped and identified as positive when the signal went above 1000-1200 units. Therefore, time (instead of signal) generates the dose response curve. The assay was stopped (if there was no signal above 1000-1200 units) at 6 minutes total time (340 seconds+20 seconds incubation time). There was determined to be variation between the two stock solutions. This is most likely due to vial to vial variation. One of the 1×10³ org/test runs stopped at 326 seconds instead of ˜360 seconds. It could be that the reader detected a signal but that data point did not transmit through Bluetooth correctly. Results are shown in the tables below. Table 1 shows analytical sensitivity.

TABLE 1
Analytical Sensitivity

| Stock 1 | | | | | Stock 2 | | | | |
|---|---|---|---|---|---|---|---|---|---|
| Concentration | Time | Control | Test | Remarks | Concentration | Time | Control | Test | Remarks |
| 1E5 org per swab | 60 | 8635 | 2056 | n = 1 | 5E3 org per | 231 | 41548 | 1403 | n = 1 |
| | | | | | swab | | | | |
| 1E5 org per swab | 62 | 7706 | 2055 | n = 2 | 5E3 org per | 201 | 39064 | 1096 | n = 2 |
| | | | | | swab | | | | |
| 1E5 org per swab | 61 | 7706 | 2350 | n = 3 | 5E3 org per | 236 | 45129 | 1109 | n = 3 |
| | | | | | swab | | | | |
| 5E4 org per swab | 101 | 8781 | 2085 | n = 1 | 1E3 org per | 346 | 49333 | 1019 | n = 1 |
| | | | | | swab | | | | |
| 5E4 org per swab | 80 | 16335 | 2065 | n = 2 | 1E3 org per | 326 | 47138 | 0 | n = 2 |
| | | | | | swab | | | | |
| 5E4 org per swab | 70 | 8529 | 1682 | n = 3 | 1E3 org per | 297 | 48149 | 1037 | n = 3 |
| | | | | | swab | | | | |
| 1E4 org per swab | 85 | 15341 | 1557 | n = 1 | 500 org per | 360 | 50570 | 0 | n = 1 |
| | | | | | swab | | | | |
| 1E4 org per swab | 106 | 22229 | 1655 | n = 2 | 500 org per | 363 | 49915 | 0 | n = 2 |
| | | | | | swab | | | | |
| 1E4 org per swab | 90 | 19117 | 1876 | n = 3 | | | | | |
| 5E3 org per swab | 135 | unknown | 1428 | n = 1 | | | | | |
| 5E3 org per swab | 103 | 20777 | 1355 | n = 2 | | | | | |
| 5E3 org per swab | 101 | unknown | 1434 | n = 3 | | | | | |
| 1E3 org per swab | 180 | 37764 | 1160 | n = 1 | | | | | |
| 1E3 org per swab | 186 | 31612 | 1809 | n = 2 | | | | | |
| 1E3 org per swab | 148 | 33249 | 1297 | n = 3 | | | | | |
| 500 org per swab | 221 | unknown | 1253 | n = 1 | | | | | |
| 500 org per swab | 185 | 32324 | 1220 | n = 2 | | | | | |
| 500 org per swab | 220 | 42835 | 1363 | n = 3 | | | | | |
| 100 org per swab | 348 | unknown | 1229 | n = 1 | | | | | |
| 100 org per swab | 357 | 49712 | 1190 | n = 2 | | | | | |
| negative | 363 | 45312 | 0 | n = 1 | | | | | |
| negative | 363 | 43331 | 0 | n = 2 | | | | | |
| negative | 363 | 44930 | 0 | n = 3 | | | | | |

### Example 3

### Specificity Study

Twenty presumed negative in-house throat swabs were evaluated on the apparatus based strep A test according to the above method. The assay was stopped (if there was no signal above 1000-1200 units) at 6 minutes total time (340 seconds+20 seconds incubation time). The results of the twenty in-house presumed negative throat swabs are recorded in table 2. None of the throat swabs generated a signal greater than 1000-1200 units during the analysis. The apparatus-based Strep A test was determined to have no specificity problems with the in-house presumed negative throat swabs.

TABLE 2
Specificity results for 20 Presumed Negative Throat Swabs

| | Time Test Stopped | Time Stopped + | | |
|---|---|---|---|---|
| Sample | (s) | 20 s incubation | Signal | Result |
| 539431 | 340 | 360 | 0 | Negative |
| 625566 | 340 | 360 | 0 | Negative |
| 609281 | 340 | 360 | 0 | Negative |
| 404048 | 340 | 360 | 0 | Negative |
| 500021 | 340 | 360 | 0 | Negative |
| 913449 | 340 | 360 | 0 | Negative |
| 359936 | 340 | 360 | 0 | Negative |
| 400498 | 340 | 360 | 0 | Negative |
| 333219 | 340 | 360 | 0 | Negative |
| 800111 | 340 | 360 | 0 | Negative |
| 498060 | 340 | 360 | 0 | Negative |
| 220986 | 340 | 360 | 0 | Negative |
| 252785 | 340 | 360 | 0 | Negative |
| 421321 | 340 | 360 | 0 | Negative |
| 544442 | 340 | 360 | 0 | Negative |
| 618880 | 340 | 360 | 0 | Negative |
| 204955 | 340 | 360 | 0 | Negative |
| 447888 | 340 | 360 | 0 | Negative |
| 263462 | 340 | 360 | 0 | Negative |
| 660880 | 340 | 360 | 0 | Negative |

### Example 4

### Clinical Study

A collection of twenty-six positive and sixty-five negative clinical samples obtained during the 2007-2008 season were stored at −80° C. and evaluated on the apparatus-based Strep A test. All swabs were streaked onto culture plates before being frozen. Table 3 compares results against culture and against the BinaxNOW® Strep A Test. The assay was stopped (if there was no signal above 1000-1200 units) at 6 minutes total time (340 seconds+20 seconds incubation time). Results at different time points are recorded. Table 4 shows sensitivity and specificity at different time points. Table 5 shows sensitivity and specificity with PCR referee. The apparatus-based Strep A test was successful in detecting Strep A in clinical samples. It appears to be so sensitive that it even detects real infections that culture misses.

TABLE 3
Results against Culture

| | | | | Seconds | | |
|---|---|---|---|---|---|---|
| | | | | after | | |
| | | | Reader | 20 sec | | BNX |
| Site | Sample | TS Cul | Result | incubation | TS cul | −/+ |
| 1 | 41 | Negative | Correct | 340 | 0 | N |
| 2 | 64 | Negative | Correct | 309 | 0 | N |
| | | | Until | | | |
| 2 | 65 | Negative | Correct | 340 | 0 | N |
| 2 | 66 | Negative | Correct | 340 | 0 | N |
| 2 | 67 | Negative | Correct | 169 | 0 | N |
| | | | Until | | | |
| 2 | 68 | Negative | Correct | 340 | 0 | N |
| 2 | 69 | Positive | Correct | 78 | 4+ | P |
| 2 | 70 | Negative | Correct | 340 | 0 | N |
| 2 | 71 | Negative | Correct | 340 | 0 | N |
| 2 | 72 | Negative | Correct | 340 | 0 | N |
| 2 | 73 | Negative | Correct | 340 | 0 | N |
| 2 | 75 | Negative | Correct | 340 | 0 | N |
| 2 | 77 | Negative | Correct | 340 | 0 | N |
| 2 | 78 | Negative | Correct | 340 | 0 | N |
| 2 | 79 | Negative | Correct | 340 | 0 | N |
| 2 | 80 | Negative | Correct | 340 | 0 | N |
| 2 | 81 | Negative | Correct | 316 | 0 | N |
| | | | Until | | | |
| 2 | 82 | Negative | Correct | 340 | 0 | N |
| 2 | 84 | Negative | Correct | 340 | 0 | N |
| 2 | 85 | Negative | Correct | 340 | 0 | N |
| 2 | 86 | Negative | Correct | 340 | 0 | N |
| 2 | 87 | Positive | Correct | 39 | 2+ | N |
| 2 | 88 | Negative | Correct | 340 | 0 | N |
| 2 | 89 | Negative | Correct | 340 | 0 | N |
| 2 | 90 | Negative | Correct | 340 | 0 | N |
| 4 | 111 | Positive | Incorrect | 340 | 2+ | N |
| 4 | 113 | Negative | Incorrect | 43 | 0 | P |
| 4 | 114 | Positive | Correct | 64 | 4+ | P |
| 4 | 115 | Negative | Correct | 340 | 0 | N |
| 4 | 116 | Negative | Correct | 145 | 0 | P |
| | | | Until | | | |
| 4 | 117 | Negative | Correct | 215 | 0 | N |
| | | | Until | | | |
| 4 | 118 | Negative | Correct | 340 | 0 | N |
| 4 | 119 | Negative | Correct | 340 | 0 | N |
| 4 | 120 | Negative | Correct | 340 | 0 | N |
| 4 | 121 | Negative | Correct | 340 | 0 | N |
| 4 | 123 | Positive | Correct | 74 | 4+ | P |
| 4 | 136 | Negative | Correct | 340 | 0 | N |
| 4 | 145 | Positive | Correct | 38 | 4+ | N |
| 4 | 152 | Positive | Correct | 37 | 4+ | P |
| 4 | 163 | Positive | Correct | 38 | 3+ | P |
| 6 | 52 | Negative | Correct | 340 | 0 | N |
| 6 | 53 | Positive | Correct | 99 | 3+ | N |
| 6 | 56 | Positive | Correct | 37 | 3+ | N |
| 6 | 57 | Positive | Correct | 40 | 4+ | P |
| 6 | 58 | Negative | Correct | 340 | 0 | N |
| 6 | 59 | Negative | Correct | 340 | 0 | N |
| 6 | 60 | Negative | Correct | 340 | 0 | N |
| 6 | 61 | Negative | Correct | 340 | 0 | N |
| 6 | 64 | Negative | Correct | 340 | 0 | N |
| 6 | 67 | Negative | Correct | 340 | 0 | N |
| 6 | 68 | Negative | Correct | 340 | 0 | N |
| 6 | 72 | Positive | Correct | 74 | 4+ | P |
| 6 | 73 | Positive | Correct | 40 | 4+ | P |
| 6 | 87 | Positive | Correct | 40 | 4+ | P |
| 6 | 91 | Positive | Correct | 40 | 4+ | P |
| 6 | 94 | Positive | Correct | 141 | 2+ | N |
| 6 | 110 | Negative | Correct | 340 | 0 | N |
| 6 | 113 | Negative | Correct | 340 | 0 | N |
| 6 | 120 | Negative | Correct | 340 | 0 | N |
| 6 | 121 | Positive | Incorrect | 340 | 2+ | N |
| | | | | | (none in 1) | |
| 6 | 122 | Positive | Correct | 249 | 2+ | N |
| | | | | | (none in 1) | |
| 6 | 125 | Negative | Correct | 116 | 0 | N |
| | | | Until | | | |
| 6 | 126 | Negative | Correct | 340 | 0 | N |
| 6 | 127 | Negative | Correct | 340 | 0 | N |
| 6 | 128 | Positive | Correct | 47 | 3+ | P |
| 6 | 129 | Negative | Correct | 340 | 0 | N |
| 6 | 130 | Negative | Correct | 340 | 0 | N |
| 6 | 131 | Positive | Correct | 40 | 4+ | N |
| 6 | 132 | Positive | Correct | 61 | 2+ | N |
| 6 | 136 | ? | ? | 40 | NOT | |
| | | | | | Counted | |
| | | | | | below | |
| 6 | 136 | ? | ? | 129 | NOT | |
| | | | | | Counted | |
| | | | | | below | |
| 6 | 137 | Negative | Correct | 340 | 0 | N |
| 6 | 139 | Negative | Correct | 340 | 0 | N |
| 6 | 140 | Negative | Correct | 340 | 0 | N |
| 6 | 144 | Negative | Correct | 340 | 0 | N |
| 6 | 145 | Negative | Correct | 340 | 0 | N |
| 6 | 146 | Negative | Correct | 340 | 0 | N |
| 6 | 147 | Negative | Correct | 340 | 0 | N |
| 6 | 148 | Negative | Correct | 340 | 0 | N |
| 6 | 149 | Negative | Correct | 340 | 0 | N |
| 6 | 151 | Negative | Correct | 340 | 0 | N |
| 6 | 152 | Negative | Correct | 340 | 0 | N |
| 6 | 153 | Negative | Correct | 340 | 0 | N |
| 6 | 154 | Negative | Correct | 340 | 0 | N |
| 6 | 155 | Negative | Correct | 340 | 0 | N |
| 6 | 157 | Negative | Correct | 340 | 0 | N |
| 6 | 165 | Negative | Correct | 308 | 0 | N |
| | | | Until | | | |
| 6 | 170 | Positive | Correct | 83 | 2+ | N |
| | | | | | (? In 1) | |
| 6 | 171 | Positive | Correct | 43 | 4+ | P |
| 6 | 177 | Positive | Correct | 36 | 2+ | N |
| | | | | | (none in 1) | |
| 6 | 184 | Positive | Correct | 64 | 4+ | P |
| 6 | 187 | Negative | Correct | 340 | 0 | N |
| 6 | 196 | Positive | Correct | 38 | 4+ | P |

TABLE 4
Sensitivity/Specificity at different time points
100 sec run time (2 min total time)

| | | |
|---|---|---|
| Sensitivity | 85% | Missed 4 at 100 sec |
| Specificity | 98% | Missed 1 at 100 sec |

160 sec run time (3 min total time)

| | | |
|---|---|---|
| Sensitivity | 88% | Missed 3, at 160 sec |
| Specificity | 94% | Missed 4, at 160 sec |

280 sec run time (5 min total time)

| | | |
|---|---|---|
| Sensitivity | 92% | Missed 2, at 280 sec |
| Specificity | 92% | Missed 5, at 280 sec |

TABLE 5
Sensitivity/Specificity with PCR Referee

| | | | | BNX | | |
|---|---|---|---|---|---|---|
| | | Saliva | | NOW | BDR | |
| Site | ID | Culture | TS culture | result | result | PCR result |
| 2 | 64 | N | N | N | P at 309 s | INHIBITED |
| 2 | 67 | N | N | N | P at 169 s | INHIBITED |
| 2 | 81 | N | N | N | P at 316 s | INHIBITED |
| 4 | 111 | N | 2+ | N | N | INHIBITED |
| 4 | 113 | N | N | P | P at 43 s | P |
| 4 | 115 | 3+ | N | N | N | N |
| 4 | 116 | N | N | P | P 145 s | P |
| 4 | 117 | N | N | N | P 215 s | P |
| 4 | 121 | 3+ | N | N | N | INHIBITED |
| 4 | 136 | 2+ | N | N | N | N |
| 6 | 121 | 1+ | 2+ | N | N | INHIBITED |
| | | | (none in 1) | | | |
| 6 | 122 | N | 2+, | N | P at 249 s | P |
| | | | None in 1 | | | |
| 6 | 125 | N | N | N | P at 116 | P |
| 6 | 165 | N | N | N | P at 308 | INHIBITED |

at time = 100 seconds
(or the read that was closest to 100 s without going under 100 s)

| | | |
|---|---|---|
| Sensitivity = | 76.70% | 23 out of 30 |
| Specificity = | 100% | 61 out of 61 |

at time = 160 seconds
(or the read that was closest to 160 s without going under 160 s)

| | |
|---|---|
| Sensitivity = | 26 out of 30 |
| 86.6% | |
| Specificity = | 60 out of 61 |
| 98.3% | |

at time = 280 s (or the read closest to 280 s without going under 280 s)

| | |
|---|---|
| Sensitivity = | 28 out of 30 |
| 93.3% | |
| Specificity = | 60 out of 61 |
| 98.3% | |

### Example 5

### Comparison of Low-Cost Apparatus to Gold Standard Apparatus

The dye Congo red was diluted and sprayed onto nitrocellulose using a Biodot XYZ. The RTG (SN2) was compared against the NES Unipath QC reader. Machine % CV (reading the same strip n=20 times) was compared at a variety of dilutions. Strip to strip % CV was compared at a variety of dilutions. Table 6 shows the machine % CV of SN2 (RTG). Table 7 shows the machine % CV of NES Unipath QC Reader. Table 8 shows the strip to strip % CV at high dose (SN2 Vs NES). Table 9 shows the strip to strip % CV at mid-low dose (SN2 Vs NES). Table 10 shows the strip to strip % CV at low-zero dose (SN2 Vs NES). The data showed that the RTG (SN2) is equivalent in sensitivity and precision to the NES Unipath QC Reader.

TABLE 6
Machine % CV of SN2 (RTG)

| | Sn2 | | | | | |
|---|---|---|---|---|---|---|
| | 0.1 | 0.05 | 0.025 | 0.01 | 0.005 | 0 mg/ |
| | mg/mL | mg/mL | mg/mL | mg/mL | mg/mL | mL |
| | 9963 | 8040 | 4861 | 1485 | 671 | 0 |
| | 9901 | 8133 | 4850 | 1526 | 648 | 0 |
| | 9940 | 8164 | 4834 | 1508 | 706 | 0 |
| | 9931 | 8067 | 4877 | 1489 | 697 | 0 |
| | 9954 | 8134 | 4800 | 1514 | 677 | 0 |
| | 9921 | 7950 | 4857 | 1459 | 687 | 0 |
| | 9954 | 8120 | 4824 | 1461 | 700 | 0 |
| | 10049 | 8116 | 4888 | 1501 | 744 | 0 |
| | 9954 | 8110 | 4870 | 1475 | 676 | 0 |
| | 9921 | 8106 | 4856 | 1517 | 718 | 0 |
| | 9954 | 8150 | 4781 | 1461 | 694 | 0 |
| | 10035 | 8169 | 4830 | 1464 | 715 | 0 |
| | 9988 | 8160 | 4777 | 1482 | 692 | 0 |
| | 9922 | 8087 | 4786 | 1522 | 682 | 0 |
| | 9966 | 8127 | 4818 | 1484 | 697 | 0 |
| | 9938 | 8131 | 4813 | 1486 | 640 | 0 |
| | 9971 | 8093 | 4804 | 1486 | 687 | 0 |
| | 9969 | 7995 | 4799 | 1494 | 764 | 0 |
| | 9977 | 8092 | 4817 | 1456 | 679 | 0 |
| | 9925 | 8152 | 4814 | 1496 | 646 | 0 |
| Avg | 9957 | 8105 | 4828 | 1488 | 691 | 0 |
| STD | 36 | 55 | 32 | 21 | 29 | 0 |
| % | 0.36% | 0.68% | 0.66% | 1.42% | 4.27% | NA |
| CV | | | | | | |

TABLE 7
Machine % CV of NES Unipath QC Reader

| | NES Area | | | | | |
|---|---|---|---|---|---|---|
| | 0.1 | 0.05 | 0.025 | 0.01 | 0.005 | |
| | mg/mL | mg/mL | mg/mL | mg/mL | mg/mL | 0 mg/mL |
| | 1019 | 604 | 284 | 78 | 33 | 0.00 |
| | 1017 | 603 | 288 | 79 | 34 | 0.00 |
| | 1016 | 603 | 289 | 79 | 35 | 0.00 |
| | 1016 | 602 | 285 | 80 | 38 | 0.00 |
| | 1015 | 603 | 286 | 78 | 33 | 0.00 |
| | 1015 | 602 | 285 | 78 | 33 | 0.00 |
| | 1014 | 600 | 293 | 79 | 31 | 0.00 |
| | 1014 | 600 | 284 | 82 | 33 | 0.00 |
| | 1011 | 601 | 285 | 79 | 33 | 0.00 |
| | 1013 | 599 | 284 | 80 | 31 | 0.00 |
| | 1009 | 599 | 286 | 81 | 34 | 0.00 |
| | 1010 | 600 | 286 | 79 | 32 | 0.00 |
| | 1008 | 597 | 288 | 79 | 32 | 0.00 |
| | 1010 | 599 | 294 | 78 | 33 | 0.00 |
| | 1008 | 598 | 285 | 79 | 36 | 0.00 |
| | 1008 | 596 | 286 | 78 | 33 | 0.00 |
| | 1008 | 598 | 292 | 79 | 33 | 0.00 |
| | 1007 | 597 | 290 | 80 | 33 | 0.00 |
| | 1009 | 595 | 293 | 78 | 32 | 0.00 |
| | 1007 | 594 | 294 | 79 | 31 | 0.00 |
| Avg | 1012 | 599 | 288 | 79 | 33 | 0 |
| STD | 4 | 3 | 3 | 1 | 2 | 0 |
| % CV | 0.37% | 0.45% | 1.20% | 1.09% | 4.76% | NA |

TABLE 8
Strip to Strip % CV at high dose (SN2 Vs NES)

| | SN2 | NES | | SN2 | NES | |
|---|---|---|---|---|---|---|
| | 0.1 | PH | Area | 0.05 | PH | Area |
| | mg/mL | 0.1 mg/mL | | mg/mL | 0.05 mg/mL | |
| | 9737 | 20.5 | 1032 | 8044 | 12.65 | 571.27 |
| | 9830 | 20.2 | 1010 | 8211 | 13.20 | 556.76 |
| | 10208 | 20.7 | 1008 | 8087 | 12.64 | 577.95 |
| | 10352 | 20.4 | 995 | 8224 | 12.74 | 564.15 |
| | 9341 | 20.0 | 1051 | 8114 | 13.31 | 611.44 |
| | 9924 | 20.8 | 1034 | 7886 | 12.45 | 566.06 |
| | 10143 | 20.7 | 1026 | 7969 | 13.09 | 565.26 |
| | 10423 | 19.4 | 980 | 7847 | 12.82 | 572.79 |
| | 9277 | 18.9 | 1016 | 8079 | 13.35 | 590.11 |
| | 10627 | 19.8 | 943 | 8102 | 12.89 | 587.67 |
| | 9803 | 19.7 | 1023 | 8047 | 13.30 | 604.59 |
| | 9821 | 19.6 | 1020 | 7876 | 12.97 | 593.78 |
| | 10153 | 21.1 | 1026 | 8136 | 12.89 | 578.77 |
| | 10471 | 20.4 | 971 | 7921 | 12.71 | 565.74 |
| | 10209 | 20.7 | 1013 | 8196 | 13.17 | 593.13 |
| | 9256 | 19.0 | 1050 | 8054 | 12.80 | 585.80 |
| | 9107 | 19.7 | 1024 | 7984 | 12.92 | 587.20 |
| | 10070 | 20.3 | 999 | 7942 | 13.00 | 575.34 |
| | 9811 | 20.5 | 1029 | 7985 | 12.73 | 528.77 |
| | 10427 | 20.6 | 975 | 7906 | 12.84 | 588.38 |
| Avg | 9950 | 20.1 | 1011 | 8031 | 12.9 | 578 |
| STD | 430 | 1 | 27 | 112 | 0 | 18 |
| % CV | 4.3% | 2.9% | 2.6% | 1.4% | 1.9% | 3.1% |

TABLE 9
Strip to Strip % CV at mid-low dose (SN2 Vs NES)

| | SN2 | NES | | SN2 | NES | |
|---|---|---|---|---|---|---|
| | 0.025 | PH | Area | 0.01 | PH | Area |
| | mg/mL | 0.025 mg/mL | | mg/mL | 0.01 mg/mL | |
| | 4754 | 7.88 | 288 | 1526 | 2.31 | 80 |
| | 4898 | 8.14 | 299 | 1462 | 2.67 | 85 |
| | 4946 | 8.01 | 284 | 1565 | 2.64 | 83 |
| | 4936 | 7.99 | 285 | 1465 | 2.64 | 88 |
| | 4827 | 8.08 | 289 | 1473 | 2.69 | 86 |
| | 4724 | 7.82 | 282 | 1652 | 2.60 | 88 |
| | 4814 | 7.80 | 294 | 1535 | 2.58 | 85 |
| | 4776 | 7.94 | 294 | 1484 | 2.41 | 80 |
| | 4826 | 7.79 | 287 | 1512 | 2.59 | 86 |
| | 4908 | 8.42 | 278 | 1550 | 2.61 | 87 |
| | 4789 | 7.83 | 295 | 1483 | 2.48 | 78 |
| | 4786 | 7.92 | 292 | 1528 | 2.62 | 85 |
| | 4726 | 8.03 | 297 | 1544 | 2.88 | 87 |
| | 4954 | 8.00 | 284 | 1548 | 2.64 | 87 |
| | 4769 | 7.80 | 287 | 1395 | 2.54 | 83 |
| | 4766 | 7.80 | 290 | 1495 | 2.52 | 82 |
| | 4803 | 7.78 | 284 | 1486 | 2.61 | 83 |
| | 4866 | 8.13 | 280 | 1498 | 2.61 | 91 |
| | 4801 | 8.10 | 296 | 1505 | 2.64 | 83 |
| | 4891 | 7.76 | 284 | 1463 | 2.53 | 84 |
| Avg | 4828 | 7.9 | 288 | 1508 | 2.59 | 85 |
| STD | 71 | 0 | 6 | 51 | 0 | 3 |
| % CV | 1.5% | 2.1% | 2.0% | 3.4% | 4.3% | 3.8% |

TABLE 10
Strip to Strip % CV at low-Zero dose (SN2 Vs NES)

| | | NES | | | NES | |
|---|---|---|---|---|---|---|
| | SN2 | PH | Area | SN2 | PH | Area |
| | 0.005 mg/mL | 0.005 mg/mL | | 0 mg/mL | 0 mg/mL | |
| | 628 | 1.14 | 30.13 | 0 | 0.00 | 0.00 |
| | 619 | 1.12 | 28.30 | 0 | 0.00 | 0.00 |
| | 595 | 1.46 | 33.71 | 0 | 0.00 | 0.00 |
| | 606 | 1.04 | 31.27 | 0 | 0.00 | 0.00 |
| | 566 | 1.09 | 30.70 | 0 | 0.00 | 0.00 |
| | 708 | 1.11 | 29.09 | 0 | 0.00 | 0.00 |
| | 794 | 1.04 | 27.20 | 0 | 0.00 | 0.00 |
| | 681 | 1.03 | 27.20 | 0 | 0.00 | 0.00 |
| | 639 | 0.99 | 24.26 | 0 | 0.00 | 0.00 |
| | 702 | 1.23 | 34.66 | 0 | 0.00 | 0.00 |
| | 698 | 1.06 | 28.60 | 0 | 0.00 | 0.00 |
| | 685 | 1.18 | 35.62 | 0 | 0.00 | 0.00 |
| | 614 | 1.16 | 31.13 | 0 | 0.00 | 0.00 |
| | 608 | 0.97 | 28.77 | 0 | 0.00 | 0.00 |
| | 603 | 1.14 | 35.15 | 0 | 0.00 | 0.00 |
| | 619 | 1.07 | 27.38 | 0 | 0.00 | 0.00 |
| | 689 | 1.52 | 45.54 | 0 | 0.00 | 0.00 |
| | 653 | 1.06 | 31.55 | 0 | 0.00 | 0.00 |
| | 665 | 1.06 | 30.03 | 0 | 0.00 | 0.00 |
| | 577 | 0.99 | 27.03 | 0 | 0.00 | 0.00 |
| Avg | 647 | 1.12 | 31 | 0 | 0.00 | 0 |
| STD | 54 | 0 | 4 | 0 | 0 | 0 |
| % CV | 8.3% | 12.3% | 14.4% | NA | NA | NA |

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. An apparatus for optically reading test devices having an identification data zone associated with the test device and test zone arranged to receive a sample comprising: an optical sensing module; an image processing module coupled to the optical sensing module; and a control module coupled to the optical sensing module and to the image processing module, wherein the optical sensing module is arranged to sense the test zone and the identification data zone and deliver the sensed data to the image processing module responsive to the control module, and wherein the image processing unit is arranged to perform image processing on the sensed data from the test zone and from the identification data zone and further determine the sample according to the sensed data from the test zone in view of the sensed data from the identification data zone responsive to the control unit.

2. The apparatus according to claim 1, wherein the control module is further arranged to store all sensed data and or analyzed parts thereof in association with the identification data.

3. The apparatus according to claim 1, wherein the sample is one of: a biological material; a bodily substance; a chemical specimen; and any other chemical reaction visible to an optical sensing device.

4. The apparatus according to claim 1, wherein the identification data is one of: a type of test; a mode of test; calibration data; data of production; an identification number; a batch number; and any data that is representable in an optical form

5. The apparatus according to claim 1, wherein the identification data contains a graphical calibration of the test, such that the calibration data contains a plurality of parameters which are used to calibrate the test results according to different functions

6. The apparatus according to claim 1, wherein the identification data contains biometric information related to one or more of: the test; the patient; a donor; and the tester.

7. The apparatus according to claim 1, wherein the test zone is arranged to receive a sample and provides a visual representation of properties pertaining to the sample according to a predefined key.

8. The apparatus according to claim 1, wherein the optical sensing module is arranged to optically sense the test zone and the identification data zone simultaneously.

9. The apparatus according to claim 1, wherein the optical sensing module comprises an optical unit and a digital imaging module, and wherein the digital imaging module, the image processing module, and the control module are implemented on one of: a single integrated circuit; a single substrate; and a combination thereof

10. The apparatus according to claim 1, further comprising a printed circuit board, and wherein the optical sensing module, the image processing module, and the control module are implemented on a single printed circuit board.

11. The apparatus according to claim 1, further comprising one of: a rechargeable power source; batteries; and external power supply or wherein the rechargeable power source comprises an electromagnetic based electricity generator operatively associates with a complementary power source activator located on the test device, wherein charging of the rechargeable power source is achieved in cooperation of the apparatus and the test device.

12. The apparatus according to claim 1, further comprising a restriction module coupled to the control module, wherein the restriction module is arranged to store restriction data pertaining to restricting the use the test devices and wherein the control data is further arranged to restrict the use of the apparatus responsive to the restriction data.

13. The apparatus according to claim 1, wherein the apparatus is activated upon insertion of the test device thereto.

14. The apparatus according to claim 1, wherein the restriction data is one of: an upper bound of number of test devices; identification data associated with predefined test devices; a batch number of test device; a delivery number of test device; a serial number of test device; an expiration date of test device; and a type of test.

15. The apparatus according to claim 1, further comprising a user interface module and, wherein the user interface module is coupled to the control unit, wherein the user interface is arranged to enable a user to select a mode and type of operation from a predefined modes and types of operation.

16. The apparatus according to claim 1, wherein said apparatus is adapted to send the test results are sent to a server or terminal or printer in a remote location by one of: a Universal Serial Bus (USB) interface; a cellular, radio frequency (RF) interface; an optical interface; and a line interface.

17. The apparatus according to claim 1, wherein the apparatus comprises a disposable portion and a reusable portion and wherein the disposable portion is arranged to disengage from the reusable portion.

18. A method of optically sensing a test device having an identification data zone associated with the test device and a test zone arranged to receive a sample, the method comprising: optically sensing the test zone; optically sensing the identification data zone; and processing the sensed data from the test zone in view of the sensed data from the identification data zone for determining the properties of the sample.

19. The method of claim 18, wherein optically sensing the test zone and optically sensing the identification data zone occur simultaneously or sequentially.

20. The method of claim 18, wherein said processing the sensed data provides biometric identification of the provider of the sample or wherein the test results are concealed from the immediate user and are delivered to a remote site for further analysis.
